(19) United States
(12) Patent Application Publication
(10) Pub. No.: US 2011/0163469 A1
(43) Pub. Date: Jul. 7, 2011

(54) HIGH-THROUGHPUT FABRICATION OF MICROPARTICLES

(75) Inventors: Steven Little, Allison Park, PA (US); Daniel G. Anderson, Sudbury, MA (US); Robert S. Langer, Newton, MA (US)

(73) Assignee: MASSACHUSETTS INSTITUTE OF TECHNOLOGY, Cambridge, MA (US)

(21) Appl. No.: 12/094,098

(22) PCT Filed: Dec. 13, 2006
(86) PCT No.: PCT/US2006/047519

§ 371 Date: Mar. 18, 2011

Related U.S. Application Data
(60) Provisional application No. 60/750,953, filed on Dec. 16, 2005.

(51) Int. Cl. B29B 9/00

(52) U.S. Cl. 264/9; 264/5; 425/10; 425/8

(57) ABSTRACT

The high-throughput fabrication of microparticles based on the double emulsion/solvent evaporation technique for screening and optimizing microparticle formulations for particular characteristics allows for the preparation of multiple microparticle formulations in parallel. The system involves the formation of an emulsion containing aqueous bubbles with the payload in an organic phase containing the polymer or polymer blend being used for the microparticles. This first emulsion is then transferred to a larger aqueous phase, and a second waterin-oil-in water emulsion is formed. The organic solvent is then removed, and the resulting particles are optionally washed and/or freeze dried. The resulting microparticles are similar or better than microparticles prepared using the traditional one formulation at a time approach. The high-throughput fabrication of microparticles is particularly useful in optimizing microparticles formulations for drug delivery.

### RELATED APPLICATIONS

The present application claims priority under 35 U.S.C. §119(e) to U.S. provisional patent application, U.S. Ser. No. 60/750,953, filed Dec. 16, 2005, which is incorporated herein by reference.

### BACKGROUND OF THE INVENTION

The controlled release of proteins from biocompatible polymer matrices was first reported in 1976, and has since revolutionized the way therapeutic agents are used in the clinic (Langer, R. & Folkman, J. Polymers for the sustained release of proteins and other macromolecules. Nature 263, 797-800 (1976); incorporated herein by reference). A popular and extremely attractive method for releasing these materials is through polymeric microparticles which entrap the drug to be administered. This technology has been utilized to encapsulate and release therapeutic proteins suitable for applications such as anti-cancer treatments (Lupron Depot), local delivery of anesthetics (Lalla, J. K. & Sapna, K. Biodegradable microspheres of poly(DL-lactic acid) containing piroxicam as a model drug for controlled release via the parenteral route. J Microencapsul 10, 449-460 (1993); Chen, P. C. et al. Injectable microparticle-gel system for prolonged and localized lidocaine release. II. In vivo anesthetic effects. J Biomed Mater Res A 70, 459-466 (2004); each of which is incorporated herein by reference), cytokine delivery (Thomas, T. T., Kohane, D. S., Wang, A. & Langer, R. Microparticulate formulations for the controlled release of interleukin-2. J. Pharm. Sci. 93, 1100-1109 (2004); incorporated herein by reference), controlled release of steroids (Cowsar, D. R., Tice, T. R., Gilley, R. M. & English, J. P. Poly(lactide-co-glycolide) microcapsules for controlled release of steroids. Methods Enzymol. 112, 101-116 (1985); incorporated herein by reference), sustained release of protein antigen (Langer, R., Cleland, J. L. & Hanes, J. New advances in microsphere-based single-dose vaccines. Adv. Drug Deliv. Rev. 28, 97-119 (1997); incorporated herein by reference), and targeted DNA delivery (Hedley, M. L., Curley, J. & Urban, R. Microspheres containing plasmid-encoded antigens elicit cytotoxic T-cell responses. Nat. Med. 4, 365-368 (1998); incorporated herein by reference) to name a few. The particles offer protection for the encapsulated materials, which have the potential to be extremely sensitive to physiologic conditions, and have the ability to release their payload continuously or intermittently over periods of days to months (Hanes, J., Chiba, M. & Langer, R. Polymer microspheres for vaccine delivery. Pharm Biotechnol 6, 389-412 (1995); incorporated herein by reference). Another advantage of this technology is the ability to non-invasively inject the particle delivery system through a needle, avoiding the surgical implantation required when using larger delivery platforms.

One common way to prepare polymeric microparticles is through a method called the double-emulsion/solvent-evaporation technique (for review, see Odonnell, P. B. & McGinity, J. W. Preparation of microspheres by the solvent evaporation technique. Adv. Drug Deliv. Rev. 28, 25-42 (1997); incorporated herein by reference). This method allows for practically any water soluble small molecule drug, protein, DNA, etc., to be loaded into particles made from polymers such as the extremely popular, poly α-hydroxy-acids (most notably the FDA approved, poly-lactic-co-glycolic acid, or PLGA). The relatively small amount of drug-bearing, aqueous phase is finely dispersed in the immiscible, organic solvent containing the polymer by vigorous agitation to form a primary emulsion. This emulsion is then transferred to another aqueous phase containing a suitable surfactant and agitation is repeated. The result is the formation of discrete solvent droplets (secondary emulsion) containing the original aqueous, drug-loaded primary emulsion. Evaporation of the volatile solvent by stirring, followed by freeze drying yields solid polymer particles with internal, drug-loaded compartments. This process usually takes approximately 4-5 hours, and, due to the requirement of washing steps to remove the detergent, only 4-8 microparicle formulations can be prepared in one day.

Microparticles prepared in this manner are extremely versatile given that they can carry large payloads and encapsulate multiple agents. Also the size can be easily controlled by the concentration of the polymer solution, agitation speeds during fabrication, and amount of surfactant used in the outer aqueous phase. Finally, the particle surface can be coated with materials which can target or affect cells through many commonly known mechanisms. This flexibility of varying multiple parameters allows for combination therapies involving several agents, which may have synergistic effects. However, varying all of the available parameters to fully optimize a therapy can be a daunting task. Further complicating this scenario is that some therapeutic molecules such as proteins (Zhu, G., Mallery, S. R. & Schwendeman, S. P. Stabilization of proteins encapsulated in injectable poly (lactide-co-glycolide). Nat. Biotechnol. 18, 52-57 (2000); incorporated herein by reference) and plasmid DNA (Walter, E., Moelling, K., Pavlovic, J. & Merkle, H. P. Microencapsulation of DNA using poly(DL-lactide-co-glycolide): stability issues and release characteristics. J. Control. Release 61, 361-374 (1999); incorporated herein by reference) are deactivated in the particle microenvironment, requiring the need for additional stabilization agents.

### SUMMARY OF THE INVENTION

A relevant example of the number of parameters involved with optimization of a microparticle formulation is microparticulate genetic vaccine delivery. In this case, any number of plasmids expressing different antigenic epitopes can be encapsulated. Also, a number of cytokines have been shown to have tremendous promise in altering immune cells and promoting vaccine effectiveness (Luo, Y. P. et al. Plasmid DNA encoding human carcinoembryonic antigen (CEA) adsorbed onto cationic microparticles induces protective immunity against colon cancer in CEA-transgenic mice. Vaccine 21, 1938-1947 (2003); incorporated herein by reference), and therefore should be considered. Similarly, it is reasonble to think that certain known protein chemokines would attract immune cells to the particle and would be an attractive addition to microparticle formulation. Furthermore, molecules such as mannose and phosphatidylserine are involved in immune cell phagocytosis of particles and are prime candidates for microparticle surface coating for delivery to these cells. Other studies have shown that particle size plays an important role in the effectiveness of the vaccine formulation in vivo and may differ from system to system (Singh, M., Briones, M., Ott, G. & O'Hagan, D. Cationic microparticles: A potent delivery system for DNA vaccines. Proc. Natl. Acad. Sci. USA 97, 811-816 (2000); incorporated herein by reference). Finally, the polymer which is used in fabrication of the particles has been shown to drastically affect the delivery capacity of the particle (Little, S. R. et al. Poly-beta amino ester-containing microparticles enhance the activity of nonviral genetic vaccines. Proc. Natl. Acad. Sci. USA 101, 9534-9539 (2004); incorporated herein by reference) and blending two or more polymers together is sometimes desired. In this case, finding an optimal ratio is necessary (Little, S. R. et al. Poly-beta amino ester-containing microparticles enhance the activity of nonviral genetic vaccines. Proc. Natl. Acad. Sci. USA 101, 9534-9539 (2004); incorporated herein by reference). The number of possible particle formulations would then follow by:

2^{(# of cytokines)}·2^{(# of chemokines)}·2^{(# of surface labels)}·(2^{(# of plasmids)})·((# of polymers)·(# of polymer ratios)+1)·(# of particle sizes)={TOTAL # OF FORMULATIONS}

assuming that: a) all combinations of the first four terms are possible, and b) if more than one polymer is to be considered, that it would be evaluated in blends with one common polymer, such as PLGA (Little, S. R. et al. Poly-beta amino ester-containing microparticles enhance the activity of nonviral genetic vaccines. Proc Natl Acad Sci USA 101, 9534-9539 (2004); incorporated herein by reference) (# of polymer ratios does not include 100% of this common polymer to avoid repetition in the groups).

Therefore let us assume a minimalistic, but at least realistic, scenario in which we have a known, single-antigen system where in vitro and in vivo screening can be performed (i.e., the antigen is not being investigated). Also, let's assume it was desired to investigate the effects of two different polymers on delivery of some already known dosage of two different cytokines without a priori knowledge of what particle size is optimal. A realistic evaluation of polymer ratios would be 100:0, 75:25, 50:50, 25:75, and 0:100 (polymer A:polymer B). Therefore, assuming:
(# of cytokines)=2 (# of polymers)=2
(# of polymer ratios)=4 (# of surface labels)=0
(# of particle sizes)=2 {i.e., phagocytosis range, endocytosis range}
(# of chemokines)=0 (# of plasmids)=1

Using the above equation, the total number of particle formulations possible is 144. Experimental designs (factoral) may be feasible depending on what parameter is varied and can bring this number down somewhat. However, the number of required combinations would still be extremely high and preparing all formulations in a reasonable timeframe would not be realistic.

Furthermore, we have recently synthesized a library of over 2000, structurally-diverse poly(β-amino ester)s, all of which may have potential to enhance genetic vaccine delivery and adjuvancy in a similar way as the one tested in preliminary studies (Anderson, D. G., Lynn, D. M. & Langer, R. Semi-automated synthesis and screening of a large library of degradable cationic polymers for gene delivery. Angew Chem Int Ed Engl 42, 3153-3158 (2003); U.S. patent applications U.S. Ser. No. 60,239,330, filed Oct. 10, 2000; U.S. Ser. No. 60/305,337, filed Jul. 13, 2001; U.S. Ser. No. 09/969,431, filed Oct. 2, 2001; U.S. Ser. No. 10/446,444, filed May 28, 2003; U.S. Ser. No. 11/099,886, filed Apr. 6, 2005; each of which is incorporated herein by reference). Clearly, to make progress in screening even a portion of this library, especially if it is desired to vary any other parameters, it would be necessary to develop rapid methods for synthesizing formulations of these polymers on a smaller scale. The present invention provides such a system for preparing multiple microparticles formulations in parallel based on the double emulsion technique.

The present invention provides for the high-throughput fabrication of microparticles (e.g., particles with a mean diameter less than 10 μm). The high-throughput method for preparing multiple microparitcle formulations in parallel used in the present system is based on the double emulsion techique for preparing polymeric microparticles. However, the inventive system differs from the standard, larger scale double emulsion technique, in that it has been modified for the successful high-throughput fabrication of microparticles on a small-scale (e.g., less than 50 mg of microparticles) so that many formulations of microparticles can be prepared in parallel. The method allows for the preparation of microparticles containing any therapeutic, prophylactic, or diagnostic agent to be delivered including small molecule drugs, biomolecules, proteins, peptides, polynucleotides, siRNAs, RNA, DNA, etc. The method is particularly useful for formulating microparticles loaded with water soluble agents.

In one aspect, the present invention provides a high-throughput method of fabricating microparticles in parallel. The method includes (1) preparing an emulsion of an agent-bearing phase and an immiscible solution (e.g., methylene chloride, chlorofrom, ethyl acetate, etc.) containing a polymer (e.g., PLGA, poly(beta-amino ester), etc.), preferably by sonication; (2) transferring this first emulstion to a second phase containing a surfactant (e.g., polyvinyl alcohol (PVA), methyl cellulose, polysorbate 80, gelatin, etc.); and (3) forming a second emulsion, preferably by sonication. The result of these steps is the formation of discrete droplets containing one or more of the original drug-loaded droplets. As would be appreciated by one of skill in the art, acids, bases, salts, bufers, sugars, peptides, proteins, polymers, or other pharmaceutically acceptable excipients may be added to any of the solutions or emulsions prepared in the inventive method. Optional additional steps include removing any organic solvent, washing the resulting microparticles, freeze-drying the resulting microparticles, and sizing the resulting microparticles. In addition, the resulting particles may be coated. Each step of the inventive method is performed in parallel for multiple microparticle formulations allowing for the preparation of multiple formulations (at least 10, 20, 24, 30, 40, 48, 96, 192, 250, 500 or 1000 formulations) of microparticles in one experiment. In certain embodiments, the mean diameter of the particles prepared using the inventive method is less than 10 micrometers. In other embodiments, the mean diameter of the particles is less than 5 micrometers, less than 4 micrometers, less than 3 micrometers, less than 2 micrometeres, or less than 1 micrometer. Each of the microparticle formulations is prepared on a small-scalle (e.g., less than 100 mg, less than 50 mg, or less than 10 mg). The resulting microparticles preferably have the same or better characteristics (e.g., high surface integrity, size distribution, agent delivery) than the microparticles prepared using the standard larger-scale double emulsion procedure.

In another aspect, the present invention provides a high-throughput method of fabricating microparticles in parallel. The method includes (1) preparing an emulsion of an agent-bearing aqueous phase in an immiscible organic solvent (e.g., methylene chloride, chlorofrom, ethyl acetate, etc.) containing a polymer (e.g., PLGA, poly(beta-amino ester), etc.), preferably by sonication; (2) transferring this first emulstion to a second aqueous phase containing a surfactant (e.g., polyvinyl alcohol (PVA), methyl cellulose, polysorbate 80, gelatin, etc.); and (3) forming a second emulsion, preferably by sonication. The result of these steps is the formation of discrete solvent droplets containing one or more of the original aqueous, drug-loaded droplets. See FIG. 1. As would be appreciated by one of skill in the art, acids, bases, salts, bufers, sugars, peptides, proteins, polymers, or other pharmaceutically acceptable excipients may be added to any of the solutions or emulsions prepared in the inventive method. Optional additional steps include removing the organic solvent, washing the resulting microparticles, freeze-drying the resulting microparticles, and sizing the resulting microparticles. In addition, the resulting particles may be coated. Each step of the inventive method is performed in parallel for multiple microparticle formulations allowing for the preparation of multiple formulations (at least 10, 20, 24, 30, 40, 48, 96, 192, 250, 500, or 1000 formulations) of microparticles in one experiment. In certain embodiments, the mean diameter of the particles prepared using the inventive method is less than 10 micrometers. In other embodiments, the mean diameter of the particles is less than 5 micrometers, less than 4 micrometers, less than 3 micrometers, less than 2 micrometeres, or less than 1 micrometer. Each of the microparticle formulations is prepared on a small-scalle (e.g., less than 100 mg, less than 50 mg, or less than 10 mg). The resulting microparticles preferably have the same or better characteristics (e.g., high surface integrity, size distribution, agent delivery) than the microparticles prepared using the standard larger-scale double emulsion procedure.

In another aspect of the invention, the inventive method includes the formation of only one emulsion in preparing microparticles. For example, the method includes preparing an emulsion of an organic phase containing a polymer and the agent to be delivered and an aqueous phase containing a surfactant, preferably by sonication. This method is particularly useful in preparing microparticles loaded with hydrophobic agents that dissolve in organic solvent. As would be appreciated by one of skill in the art, acids, bases, salts, bufers, sugars, peptides, proteins, polymers, or other pharmaceutically acceptable excipients may be added to any of the solutions or emulsions prepared in the inventive method. Optional additional steps include removing the organic solvent, washing, freeze-drying, and sizing the resulting microparticles. The resulting particles may optionally be coated. Each step of the inventive method is performed in parallel for multiple formulations allowing for the preparation of multiple formulations (at least 10, 20, 24, 30, 40, 48, 96, 192, 250, 500, or 1000 formulations) of microparticles in one experiment. As above, in certain embodiments, the mean diameter of the particles prepared using the inventive method is less than 10 micrometers. In other embodiments, the mean diameter of the particles is less than 5 micrometers, less than 4 micrometers, less than 3 micrometers, less than 2 micrometeres, or less than 1 micrometer. Each of the microparticle formulations is prepared on a small-scalle (e.g., less than 100 mg, less than 50 mg, or less than 10 mg). The resulting microparticles preferably have the same or better characteristics (e.g., high surface integrity, size distribution, agent delivery) than the microparticles prepared using the standard larger-scale double emulsion procedure.

In another aspect, the present invention provides for an apparatus for the high-throughput fabrication of microparticles. In certain embodiments, the apparatus is specifically designed for performing the inventive methods described above. The apparatus may include a multi-tip sonicator, fluid handling robot, multi-well plate handler, and centrifuge. The apparatus may also include polymers, surfactants, agents incorporated into microparticles, organic solvent, purified water, solutions, wash solutions or buffers, pipette tips, multi-well plates, lyophilizer, vacuum pump, etc. The apparatus may also include equipment for analyzing the prepared microparticles such as a Coulter counter (e.g., Multisizer 3), zeta potential analyzer (e.g., ZetaPALS analyzer), light microscope, scanning electron microscope, plate reader, etc. Kits for measuring reporter gene expression may also be included.

### Definitions

“Animal”: The term animal, as used herein, refers to humans as well as non-human animals, including, for example, mammals, birds, reptiles, amphibians, and fish. Preferably, the non-human animal is a mammal (e.g., a rodent, a mouse, a rat, a rabbit, a monkey, a dog, a cat, a primate, or a pig). An animal may be a domesticated animal. An animal may be a transgenic animal. In certain preferred embodiments, the animal is a human.

“Associated with”: When two entities are “associated with” one another as described herein, they are linked by a direct or indirect covalent or non-covalent interaction. Preferably, the association is covalent. Desirable non-covalent interactions include hydrogen bonding, van der Waals interactions, hydrophobic interactions, magnetic interactions, electrostatic interactions, etc.

“Biocompatible”: The term “biocompatible”, as used herein is intended to describe compounds that are not toxic to cells. Compounds are “biocompatible” if their addition to cells in vitro results in less than or equal to 20% cell death, and their administration in vivo does not induce unwanted inflammation or other such adverse effects.

“Biodegradable”: As used herein, “biodegradable” compounds are those that, when introduced into cells, are broken down by the cellular machinery or by hydrolysis into components that the cells can either reuse or dispose of without significant toxic effect on the cells (i.e., fewer than about 20% of the cells are killed when the components are added to cells in vitro). The components preferably do not induce inflammation or other adverse effects in vivo. In certain preferred embodiments, the chemical reactions relied upon to break down the biodegradable compounds are uncatalyzed.

“Effective amount”: In general, the “effective amount” of an active agent or drug delivery device (e.g., microparticle formulation) refers to the amount necessary to elicit the desired biological response. As will be appreciated by those of ordinary skill in this art, the effective amount of an agent or device may vary depending on such factors as the desired biological endpoint, the agent to be delivered, the composition of the encapsulating matrix, the target tissue, etc. For example, the effective amount of microparticles containing an antigen to be delivered to immunize an individual is the amount that results in an immune response sufficient to prevent infection with an organism having the administered antigen.

“Peptide” or “protein”: According to the present invention, a “peptide” or “protein” comprises a string of at least three amino acids linked together by peptide bonds. The terms “protein” and “peptide” may be used interchangeably. Peptide may refer to an individual peptide or a collection of peptides. Inventive peptides preferably contain only natural amino acids, although non-natural amino acids (i.e., compounds that do not occur in nature but that can be incorporated into a polypeptide chain) and/or amino acid analogs as are known in the art may alternatively be employed. Also, one or more of the amino acids in an inventive peptide may be modified, for example, by the addition of a chemical entity such as a carbohydrate group, a phosphate group, a farnesyl group, an isofarnesyl group, a fatty acid group, a linker for conjugation, functionalization, or other modification, etc. In a preferred embodiment, the modifications of the peptide lead to a more stable peptide (e.g., greater half-life in vivo). These modifications may include cyclization of the peptide, the incorporation of D-amino acids, etc. None of the modifications should substantially interfere with the desired biological activity of the peptide.

“Polynucleotide” or “oligonucleotide”: Polynucleotide or oligonucleotide refers to a polymer of nucleotides. Typically, a polynucleotide comprises at least three nucleotides. The polymer may include natural nucleosides (i.e., adenosine, thymidine, guanosine, cytidine, uridine, deoxyadenosine, deoxythymidine, deoxyguanosine, and deoxycytidine), nucleoside analogs (e.g., 2-aminoadenosine, 2-thiothymidine, inosine, pyrrolo-pyrimidine, 3-methyl adenosine, C5-propynylcytidine, C5-propynyluridine, C5-bromouridine, C5-fluorouridine, C5-iodouridine, C5-methylcytidine, 7-deazaadenosine, 7-deazaguanosine, 8-oxoadenosine, 8-oxoguanosine, O(6)-methylguanine, and 2-thiocytidine), chemically modified bases, biologically modified bases (e.g., methylated bases), intercalated bases, modified sugars (e.g., 2′-fluororibose, ribose, 2′-deoxyribose, arabinose, and hexose), or modified phosphate groups (e.g., phosphorothioates and 5′-N-phosphoramidite linkages).

“Small molecule”: As used herein, the term “small molecule” refers to organic compounds, whether naturally-occurring or artificially created (e.g., via chemical synthesis) that have relatively low molecular weight and that are not proteins, polypeptides, or nucleic acids. Typically, small molecules have a molecular weight of less than about 1500 g/mol, less than about 1000 g/mol, or less than about 500 g/mol. Also, small molecules typically have multiple carbon-carbon bonds. Known naturally-occurring small molecules include, but are not limited to, penicillin, erythromycin, taxol, cyclosporin, and rapamycin. Known synthetic small molecules include, but are not limited to, ampicillin, methicillin, sulfamethoxazole, and sulfonamides.

“Surfactant”: Surfactant refers to any agent which preferentially absorbs to an interface between two immiscible phases, such as the interface between water and an organic solvent, a water/air interface, or an organic solvent/air interface. Surfactants usually possess a hydrophilic moiety and a hydrophobic moiety, such that, upon absorbing to microparticles, they tend to present moieties to the external environment that do not attract similarly-coated particles, thus reducing particle agglomeration. Surfactants may also promote absorption of a therapeutic or diagnostic agent and increase bioavailability of the agent.

### BRIEF DESCRIPTION OF THE DRAWING

FIG. 1 shows a schematic representation of an exemplary process of the high-throughput double emulsion technique for fabricating microparticles.

FIG. 2 is a fluorescent microscopy image of particles containing encapsulated rhodamine conjugated dextran sugar.

FIG. 3 is scanning electron micrographs (SEM) of particles prepared using the high-throughput double emulsion technique for fabricating microparticles. Images are 5000×. The bar in the bottom right corner of each micrograph represents the length of a 2 μm reference.

FIG. 4 shows volume impedance based size distributions of particles prepared using the high-throughput double emulsion technique. A-D. Varying PVA concentration in the outer aqueous phase results in particles with different sizes. A & B represent particles which were prepared with 0.5% PVA in the outer aqueous phase composed of 15% (Dₐᵥₑ=2.3±1.3 μm.) and 25% PBAE (Dₐᵥₑ=3.0±1.6 μm), respectively. C & D represent particles which were prepared with 5% PVA in the outer aqueous phase composed of 15% (Dₐᵥₑ=0.9±0.4 μm) and 25% PBAE (Dₐᵥₑ0.9±0.7 μm), respectively. E & F demonstrate that particles prepared in a random corner well (Dₐᵥₑ=2.2±1.4 μm) are the same size as particles prepared in a random well in the center of the plate (Dₐᵥₑ=2.4±1.9 μm).

FIG. 5 shows the structures of polymers: A. PLGA, B. Poly-1, C. Poly-2, D. Poly-3. FIG. 5E shows the transfection of P388D1 macrophages to demonstrate that active plasmid DNA can be incorporated into polymer microparcles prepared using the high-throughput double emulsion technique. Three distinct PBAEs (y-axis; Poly-1 (blue), Poly-2 (red), Poly-3 (yellow)) were prepared in deep well plates in ratios varying from 5% PBAE/95% PLGA, to 40% PBAE/60% PLGA (x-axis). These particles were resuspended in cell media and added to cell culture wells containing P388D 1 macrophages. Three days later, these cells were tested for luciferase activity as described in the materials and methods section and displayed above in relative light units (RLU) on the z-axis.

### DETAILED DESCRIPTION OF CERTAIN PREFERRED EMBODIMENTS OF THE INVENTION

The present invention provides a system for the high-throughput fabrication of mutliple formulations of microparticles in parallel. Typically, each formulation is prepared on a small scale (e.g., less than 500 mg, less than 100 mg, less than 50 mg, less than 10 mg). That is enough for an initial characterization and evaluation of the formulation. The system relies on the double emulsion or double emulsion/solvent-evaporation technique for preparing the microparticles. The system can be used to prepare microparticles for delivering any agent including small molecule drugs, biomolecules, proteins, peptides, polynucleotides, siRNA, DNA, RNA, etc. The microparticles formed using the inventive system typically have a mean diamter of less than 10 micrometers, less than 5 micrometers, less than 3 micrometers, less than 2 micrometers, or less than 1 micrometer. Typically, the mean diameter of the particles is greater than 0.1 micrometer, greater than 0.5 micrometer, or greater than 1 micrometer.

In one embodiment, the multiple formulations of microparticles are prepared in parallel by forming two emulsions. As will be appreciated by one of skill in the art, since different formulations are being prepared in each well of a multi-well plate or each container in an array of containers, different solutions or amounts of solution may be transferred at each step into the well or container. First, in each well of a multi-well plate or each containiner of an array of containers, a relatively small amount of an aqueous solution containing the agent to be incorporated into the microparticles is added to an immiscible organic phase containing a polymer. A primary emulsion of aqueous bubbles within the organic phase is formed by agitation, preferably by sonication. The sonication is typically performed using a multi-tip sonicator. Agitation may also be achieved by vigorous stirring, vortexing, homogenization.

The resulting primary emulsion of aqueous bubbles within an organic phase is then transferred to a larger volume of a second aqueous phase. The second aqueous phase optionally includes a surfactant. Varying the concentration of surfactant in the second aqueous phase can be used to adjust the mean diameter of the microparticles being formed. For example, higher concentrations of surfactant result in larger mean diametes. The resulting mixture is agitated, preferably by sonication, to form a second emulsion of water-in-oil-in-water (i.e., discrete solvent droplets containing the original aqueous, agent-loaded primary emulsion). As before, vigorous stirring, vortexing, homogenization, or other means of agitation may be used to effect the second water-in-oil-in-water emulsion. In certain embodiments of the double emulsion technique, the organic and aqueous phases are reversed. Therefore, the first emulsion is an oil-in-water emulsion, and the second emulsion is an oil-in-water-in-oil emulsion.

The volatile organic solvent is then removed by evaporation, either at atmospheric pressure or at reduced pressure, thereby forming the polymeric microparticles. In certain embodiments, the organic solvent is removed by stirring the mixture at atmospheric pressure and allowing the solvent to evaporate. The resulting microparticles are optionally washed once, twice, three times, or multiple times to remove any excess surfactant. The resulting microparticles are then optionally freeze dried (i.e., lyophilized) to yield solid polymeric microparticles with internal loaded compartments. The resulting microparticles may be coated. For example, the particles may be coated with a targeting agent to target the microparticles to specific cell, tissue, or organ. The microparticles may also be coated for stability or to adjust agent delivery kinetics.

In certain embodiments, some or all of the steps of the inventive methods are performed at reduced temperatures to minimize structural defects in the microparticles. In certain particular embodiments, some or all of the steps are performed at approximately 4° C. In certain embodiments, all the steps are performed at approximately 4° C. In certain embodiments, the steps up to and including the evaporation of the organic solvent are performed at approximately 4° C.

In certain embodiments, the multiple formulations of microparticles are prepared in parallel by forming only one emulsion. For example, when the agent to be incorporated into the microparticles is soluble in an organic solvent, only one emulsion need be formed. The agent and the polymer are dissolved in an organic solvent (e.g., ethyl acetate, methylene chloride, or chloroform). The resulting organic solution is transferred to a larger aqueous phase, and the resulting mixture is agitated, typically by sonication, to yield an emulsion. Typically, the aqueous phase includes a surfactant (e.g., PVA). The resulting emulsion contains droplets of the organic solution containing polymer and agent in the aqueous phase (i.e., an oil-in-water emulsion). The solvent is evaporated, and the resulting microparticles are optionally washed and freeze dried as described above. The microparticles may also be coated as described above.

### Agent

The agents being incorporated into the microparticles may be any therapeutic, diagnostic, or prophylactic agent. That is, any chemical compound to be administered to a subject may be incorporated into microparticles prepared by the inventive system. The agent may be a small molecule, organometallic compound, polynucleotide (e.g., DNA, RNA, siRNA, shRNA, anti-sense agents, etc.), protein, peptide, metal, an isotopically labeled chemical compound, small molecule drug, vaccine, immunological agent, biomolecule, etc. In certain embodiments, the agent is soluble in an aqueous solution or water. In other embodiments, the agent is soluble in an organic solvent (e.g., methylene chloride, chloroform, ethyl acetate).

In a preferred embodiment, the agent is an organic compound with pharmaceutical activity. In another embodiment of the invention, the agent is a clinically used drug that has been approved by the FDA. In a particularly preferred embodiment, the drug is an antibiotic, anti-viral agent, anesthetic, steroidal agent, anti-inflammatory agent, anti-neoplastic agent, antigen, vaccine, adjuvant, antibody, decongestant, antihypertensive, sedative, birth control agent, progestational agent, anti-cholinergic, analgesic, anti-depressant, anti-psychotic, β-adrenergic blocking agent, diuretic, cardiovascular active agent, vasoactive agent, non-steroidal anti-inflammatory agent, nutritional agent, etc.

The agent delivered may also be a mixture of one or more agents. In certain embodiments, two or more pharmaceutical agents are incorporated into the same microparticle. For example, two or more antibiotics may be combined in the same microparticle, or two or more anti-neoplastic agents may be combined in the same microparticle. To give but another example, an antibiotic may be combined with an inhibitor of the enzyme commonly produced by bacteria to inactivate the antibiotic (e.g., penicillin and clavulanic acid), or an anti-neoplastic agent may be combined with an inhibitor of the efflux pump P-glycoprotein (Pgp). In certain embodiments, two agents which exhibit a synergistic effect when combined are incorporated into the same microparticle. In another embodiment, an antigen may be combined with an adjuvant to increase the immune reaction generated by the antigen to be delivered.

Diagnostic agents include gases; commercially available imaging agents used in positron emissions tomography (PET), computer assisted tomography (CAT), single photon emission computerized tomography, x-ray, fluoroscopy, and magnetic resonance imaging (MRI); and contrast agents. Examples of suitable materials for use as contrast agents in MRI include gadolinium chelates, as well as iron, magnesium, manganese, copper, and chromium. Examples of materials useful for CAT and x-ray imaging include iodine-based materials.

Prophylactic agents include vaccines. Vaccines may comprise isolated proteins or peptides, inactivated organisms and viruses, dead organisms and virus, genetically altered organisms or viruses, and cell extracts. Vaccines may also include polynucleotides which encode antigenic proteins or peptides. In certain embodiments, the vaccines are cancer vaccines comprising antigens from cancer cells. Prophylactic agents may be combined with interleukins, interferon, cytokines, CpGs, and adjuvants such as cholera toxin, alum, Freund's adjuvant, etc. Prophylactic agents include antigens of such bacterial organisms as Streptococccus pnuemoniae, Haemophilus influenzae, Staphylococcus aureus, Streptococcus pyrogenes, Corynebacterium diphtheriae, Listeria monocytogenes, Bacillus anthracis, Clostridium tetani, Clostridium botulinum, Clostridium perfringens, Neisseria meningitidis, Neisseria gonorrhoeae, Streptococcus mutans, Pseudomonas aeruginosa, Salmonella typhi, Haemophilus parainfluenzae, Bordetella pertussis, Francisella tularensis, Yersinia pestis, Vibrio cholerae, Legionella pneumophila, Mycobacterium tuberculosis, Mycobacterium leprae, Treponema pallidum, Leptospirosis interrogans, Borrelia burgdorferi, Camphylobacter jejuni, and the like; antigens of such viruses as smallpox, influenza A and B, respiratory syncytial virus, parainfluenza, measles, human immunodeficiency virus (HIV), varicella-zoster, herpes simplex 1 and 2, cytomegalovirus, Epstein-Barr virus, rotavirus, rhinovirus, adenovirus, papillomavirus, poliovirus, mumps, rabies, rubella, coxsackieviruses, equine encephalitis, Japanese encephalitis, yellow fever, Rift Valley fever, hepatitis A, B, C, D, and E virus, and the like; antigens of fungal, protozoan, and parasitic organisms such as Cryptococcus neoformans, Histoplasma capsulatum, Candida albicans, Candida tropicalis, Nocardia asteroides, Rickettsia ricketsii, Rickettsia typhi, Mycoplasma pneumoniae, Chlamydial psittaci, Chlamydial trachomatis, Plasmodium falciparum, Trypanosoma brucei, Entamoeba histolytica, Toxoplasma gondii, Trichomonas vaginalis, Schistosoma mansoni, and the like. These antigens may be in the form of whole killed organisms, peptides, proteins, glycoproteins, carbohydrates, or combinations thereof. More than one antigen may be combined in a particular microparticle, or a pharmaceutical composition may include microparticles each containing different antigens or combinations of antigens. Adjuvants may also be combined with an antigen in the micorparticles. Adjuvants may also be included in pharmaceutical compositions of the microparticles.

Prophylactic agents incoporated into the microparticles may also include vitamins (e.g., vitamin A, vitamin B₁, vitamin B₂, vitamin B₃, vitamin B₅, vitamin B₆, vitamin B₁₂, vitamin D, vitamin E, vitamin K, biotin, folic acid, etc.), minerals (e.g., iron, copper, magnesium, selenium, etc.), or other nutraceuticals.

As would be appreciated by one of skill in this art, the variety and combinations of agents that can be incorporated into microparticles using the inventive system are almost limitless.

Polynucleotides are also important agents that can be incorporated into microparticles using the inventive system for the high-throughput fabrication of microparticles. The polynucleotides may be any nucleic acid including but not limited to RNA, DNA, and derivatives, analogues, and salts thereof. The polynucleotides may be of any size or sequence, and they may be single- or double-stranded. In certain embodiments, the polynucleotide is less than 50 base pairs long. In other embodiments, the polynucleotide is less than 100 bases long. In certain embodiments, the polynucleotide is greater than 100 bases long, greater than 200 base long, greater than 300 bases long, greater than 500 bases long, or greater than 750 bases long. In certain other embodiments, the polynucleotide is greater than 1000 bases long and may be greater than 10,000 bases long. The polynucleotide is preferably purified or substantially pure. Preferably, the polynucleotide is greater than 50% pure, more preferably greater than 75% pure, and most preferably greater than 95% pure. The polynucleotide may be provided by any means known in the art. In certain preferred embodiments, the polynucleotide has been engineered using recombinant techniques (for a more detailed description of these techniques, please see Ausubel et al. Current Protocols in Molecular Biology (John Wiley & Sons, Inc., New York, 1999); Molecular Cloning: A Laboratory Manual, 2nd Ed., ed. by Sambrook, Fritsch, and Maniatis (Cold Spring Harbor Laboratory Press: 1989); each of which is incorporated herein by reference). The polynucleotide may also be obtained from natural sources and purified from contaminating components found normally in nature. The polynucleotide may also be chemically synthesized in a laboratory. In a certain embodiment, the polynucleotide is synthesized using standard solid phase chemistry. In a certain embodiments, the polynucleotide is synthesized by a polynucleotide synthesizer.

The polynucleotide may optionally be modified by chemical or biological means. In certain embodiments, these modifications lead to increased stability of the polynucleotide. Modifications include methylation, phosphorylation, end-capping, etc.

Derivatives of polynucleotides may also be used in the present invention. These derivatives include modifications in the bases, sugars, and/or phosphate linkages of the polynucleotide. Modified bases include, but are not limited to, those found in the following nucleoside analogs: 2-aminoadenosine, 2-thiothymidine, inosine, pyrrolo-pyrimidine, 3-methyl adenosine, 5-methylcytidine, C5-bromouridine, C5-fluorouridine, C5-iodouridine, C5-propynyl-uridine, C5-propynyl-cytidine, C5-methylcytidine, 7-deazaadenosine, 7-deazaguanosine, 8-oxoadenosine, 8-oxoguanosine, 0(6)-methylguanine, and 2-thiocytidine. Modified sugars include, but are not limited to, 2′-fluororibose, ribose, 2′-deoxyribose, 3′-azido-2′,3′-dideoxyribose, 2′,3′-dideoxyribose, arabinose (the 2′-epimer of ribose), acyclic sugars, and hexoses. The nucleosides may be strung together by linkages other than the phosphodiester linkage found in naturally occurring DNA and RNA. Modified linkages include, but are not limited to, phosphorothioate and 5′-N-phosphoramidite linkages. Combinations of the various modifications may be used in a single polynucleotide. These modified polynucleotides may be provided by any means known in the art; however, as will be appreciated by those of skill in this art, the modified polynucleotides are preferably prepared using synthetic chemistry in vitro.

The polynucleotides to be delivered may be in any form. For example, the polynucleotide may be a circular plasmid, a linearized plasmid, a cosmid, a viral genome, a modified viral genome, an artificial chromosome, etc.

The polynucleotide may be of any sequence. In certain preferred embodiments, the polynucleotide encodes a protein or peptide. The encoded proteins may be enzymes, structural proteins, receptors, soluble receptors, ion channels, pharmaceutically active proteins, cytokines, interleukins, antibodies, antibody fragments, antigens, coagulation factors, albumin, growth factors, hormones, insulin, etc. The polynucleotide may also comprise regulatory regions to control the expression of a gene. These regulatory regions may include, but are not limited to, promoters, enhancer elements, repressor elements, TATA box, ribosomal binding sites, stop site for transcription, etc. In other particularly preferred embodiments, the polynucleotide is not intended to encode a protein. For example, the polynucleotide may be used to fix an error in the genome of the cell being transfected.

The polynucleotide may also be provided as an antisense agent or RNA interference (RNAi) (Fire et al. Nature 391:806-811, 1998; incorporated herein by reference). Antisense therapy is meant to include, e.g., administration or in situ provision of single- or double-stranded oligonucleotides or their derivatives which specifically hybridize, e.g., bind, under cellular conditions, with cellular mRNA and/or genomic DNA, or mutants thereof, so as to inhibit expression of the encoded protein, e.g., by inhibiting transcription and/or translation (Crooke “Molecular mechanisms of action of antisense drugs” Biochim. Biophys. Acta 1489(1):31-44, 1999; Crooke “Evaluating the mechanism of action of antiproliferative antisense drugs” Antisense Nucleic Acid Drug Dev. 10(2):123-126, discussion 127, 2000; Methods in Enzymology volumes 313-314, 1999; each of which is incorporated herein by reference). The binding may be by conventional base pair complementarity, or, for example, in the case of binding to DNA duplexes, through specific interactions in the major groove of the double helix (i.e., triple helix formation) (Chan et al. J. Mol. Med. 75(4):267-282, 1997; incorporated herein by reference).

In a particularly preferred embodiment, the polynucleotide to be delivered comprises a sequence encoding an antigenic peptide or protein. The polynucleotide of these vaccines may be combined with interleukins, interferon, cytokines, CpG sequences, and adjuvants such as cholera toxin, alum, Freund's adjuvant, etc. A large number of adjuvant compounds are known; a useful compendium of many such compounds is prepared by the National Institutes of Health (see Allison Dev. Biol. Stand. 92:3-11, 1998; Unkeless et al. Annu. Rev. Immunol. 6:251-281, 1998; and Phillips et al. Vaccine 10:151-158, 1992, each of which is incorporated herein by reference).

The antigenic protein or peptides encoded by the polynucleotide may be derived from such bacterial organisms as Streptococccus pneumoniae, Haemophilus influenzae, Staphylococcus aureus, Streptococcus pyrogenes, Corynebacterium diphtheriae, Listeria monocytogenes, Bacillus anthraces, Clostridium tetani, Clostridium botulinum, Clostridium perfringens, Neisseria meningitidis, Neisseria gonorrhoeae, Streptococcus mutans, Pseudomonas aeruginosa, Salmonella typhi, Haemophilus parainfluenzae, Bordetella pertussis, Francisella tularensis, Yersinia pestis, Vibrio cholerae, Legionella pneumophila, Mycobacterium tuberculosis, Mycobacterium leprae, Treponema pallidum, Leptospirosis interrogans, Borrelia burgdorferi, Camphylobacter jejuni, and the like; from such viruses as smallpox, influenza A and B, respiratory syncytial virus, parainfluenza, measles, HIV, varicella-zoster, herpes simplex 1 and 2, cytomegalovirus, Epstein-Barr virus, rotavirus, rhinovirus, adenovirus, papillomavirus, poliovirus, mumps, rabies, rubella, coxsackieviruses, equine encephalitis, Japanese encephalitis, yellow fever, Rift Valley fever, hepatitis A, B, C, D, and E virus, and the like; and from such fungal, protozoan, and parasitic organisms such as Cryptococcus neoformans, Histoplasma capsulatum, Candida albicans, Candida tropicalis, Nocardia asteroides, Rickettsia ricketsii, Rickettsia typhi, Mycoplasma pneumoniae, Chlamydial psittaci, Chlamydial trachomatis, Plasmodium falciparum, Trypanosoma brucei, Entamoeba histolytica, Toxoplasma gondii, Trichomonas vaginalis, Schistosoma mansoni, and the like.

The agent to be incorporated in the microparticles using the inventive method is dissolved in an aqueous solution. The solution may contain other chemical compounds such as fillers, pharmaceutically acceptable excipients, buffers, salts, acids, bases, sugars, etc. In certain embodiments, a pharmaceutically acceptable excipient is added to the solution. In certain embodiments, an acid, base, or buffer is added to the solution. These other chemical compounds may enhance the stability of the agent(s) being incorporated into the microparticles. For example, when an acidic agent is being loaded into the microparticles, a basic compound such as NaOH, Mg(OH)₂, sodium acetate, etc. may be used to neutralize the acidic agent. In other embodiments, a salt (e.g., NaCl, Na₂SO₄, NaI, KCl, CaCl₂, MgCl₂) is added to the solution. In other embodiments, a sugar may be added to the the solution so that the sugar is incorporated into the particle. In yet other embodiments, a protein is added to the aqueous solution. In certain embodiments, a targeting agent (e.g., receptor, ligand, antibody, antibody fragment, protein, peptide) is added to the solution so that the targeting agent is incorporated into the microparticles.

### Polymers and Polymer Blends

Any polymer may be used in the inventive high-throughput fabrication of microparticles. In certain embodiments, polymers known to be suitable for use in preparing microparticles are used. In other embodiments, polymers known to be suitable for use in use in the drug delivery arts are used. In certain emodiments, the polymer is FDA approved for use in humans and/or animals. In certain embodiments, the polymer is biocompatible. In other embodiments, the polymer is biodegradable. Polymers useful in the present invention include polyesters, polyanhydrides, polyethers, polyamides, polyacrylates, polymethacrylates, polycarbamates, polycarbonates, polystyrenes, polyureas, polyamines, polyacrylamides, poly(ethylene glycol), poly(hydroxyethylmethacrylate), poly(vinyltoluene), and poly(divinylbenzene). In certain embodiments, the polymer is a natural polymer such as a protein. In certain embodiments, the polymer is not a protein. In certain embodiments, the polymer is a mixed polymer, a linear co-polymer, a branched co-polymer, or a dendrimer branched co-polymer. In other embodiments, a synthetic polymer (e.g., poly(lactic-co-glycolic acid) (PLGA), polyglycolic acid (PGA), polyesters, polyanhydrides, polyamides, etc.) is used. In certain embodiments, the polymer is a polyester. In other embodiments, the polymer is a polyamide. In yet other embodiments, the polymer is a polyether. In other embodiments, the polymer is a polyacrylate or polymethacrylate. In certain embodiments, the polymer is a poly(alpha-hydroxy acid). In certain particular embodiments, the polymer is poly-lactic-co-glycolic acid (PLGA). In other embodiments, the polymer is poly(lactic acid) (PLA). In other embodiments, the polymer is poly(glycolic acid) (PGA). In certain particular embodiments, the polymer is a poly(beta-amino ester). Examplary poly(beta-amino ester) are described in U.S. patent applications U.S. Ser. No. 60,239,330, filed Oct. 10, 2000; U.S. Ser. No. 60/305,337, filed Jul. 13, 2001; U.S. Ser. No. 09/969,431, filed Oct. 2, 2001; U.S. Ser. No. 10/446,444, filed May 28, 2003; U.S. Ser. No. 11/099,886, filed Apr. 6, 2005; each of which is incorporated herein by reference. In certain embodiments, the polymer is a carbohydrate (e.g., dextran, fructose, fruitose, glucose, invert sugar, lactitol, lactose, maltitol, maltodextrin, maltose, mannitol, sorbitol, sucrose, trehalose, isomalt, xylitol, polydextrose, cellulose, methylcellulose, amylose, dextran, dextrin, starch, etc.). In certain embodiments, the polymer is a protein (e.g., albumin, gelatin, etc.).

In certain embodiments, the polymers used in the inventive system are prepared from one or more of the following monomers: acrylic acid, or any ester thereof, such as methyl acrylate, ethyl acrylate, propyl acrylate, butyl acrylate, 2-ethyl hexyl acrylate or glycidyl acrylate; methacrylic acid, or any ester thereof, such as methyl methacrylate, ethyl methacrylate, propyl methacrylate, butyl methacrylate, lauryl mathacrylate, cetyl methacrylate, stearyl mathacrylate, ethylene glycol dimethacrylate, tetraethylene glycol dimethacrylate, glycidyl methacrylate or N,N-(methacryloxy hydroxy propyl)-(hydroxy alkyl) amino ethyl amidazolidinone; allyl esters such as allyl methacrylate; itaconic acid, or ester thereof; crotonic acid, or ester thereof; maleic acid, or ester thereof, such as dibutyl maleate, dioctyl maleate, dioctyl maleate or diethyl maleate; styrene, or substituted derivatives thereof such as ethyl styrene, butyl styrene or divinyl benzene; monomer units which include an amine functionality, such as dimethyl amino ethyl methacrylate or butyl amino ethyl methacrylate; monomer units which include an amide functionality, such as acrylamide or methacrylamide; vinyl-containing monomers such as vinyl ethers; vinyl thioethers; vinyl alcohols; vinyl ketones; vinyl halides, such as vinyl chlorides; vinyl esters, such as vinyl acetate or vinyl versatate; vinyl nitriles, such as acrylonitrile or methacrylonitrile; vinylidene halides, such as vinylidene chloride and vinylidene fluoride; tetrafluoroethylene; diene monomers, such as butadiene and isoprene; and allyl ethers, such as allyl glycidyl ether.

In certain embodiments, the average molecular weight of the polymer ranges from 1,000 g/mol to 50,000 g/mol, preferably from 2,000 g/mol to 40,000 g/mol, more preferably from 5,000 g/mol to 20,000 g/mol, and even more preferably from 10,000 g/mol to 17,000 g/mol. In certain embodiments, the distribution of molecular weights in a polymer sample is narrowed by purification and isolation steps known in the art. In other embodiments, the polymer mixture may be a blend of polymers of different molecular weights.

Blends of polymers may also be used in the inventive high-throughput method. The blends may contain any polymers. The blends may contain 2, 3, 4, 5, 6, 7, 8, 9, 10, or more different polymers. In certain embodiments, the blend may contain 2 or 3 different polymers. In certain particular embodiments, the blend includes only two different polymers. In certain embodiments, the blend includes poly-lactic-co-glycolic acid (PLGA). In certain embodiments, the blend includes a poly(beta-amino ester).

In the inventive system, the polymer or polymer blend is dissolved in an organic solvent. Any organic solvent may be used in the fabrication system. Preferably, the organic solvent is not miscible with water. In certain embodiments, the solvent is a halogenated solvent such as carbon tetrachloride, chloroform, or methylene chloride. In certain embodiments, the solvent used to dissolve the polymer is methylene chloride. In other embodiments, the solvent is not halogenated. Exemplary non-halogenated organic solvent useful in the inventive system include ethyl acetate, diethyl ether, hexanes, tetrahyrofuran, benzene, acetonitrile, and toluene. In certain embodiments, the organic solvent used is ethyl acetate. As will be appreciated by one of skill in the art, the organic solvent to be used in the inventive method should preferably dissolve the polymer(s) being used in the microparticles, not be miscible with water, and form an emulsion with an aqueous phase.

To the solution of polymer(s) in an organic solvent can be added other materials. Any pharmaceutically acceptable excipient may be added to the solution. In certain embodiments, an acid or base is added to the solution. For example, when an acidic agent is being loaded into the microparticles, a basic compound such as NaOH, Mg(OH)₂, sodium acetate, etc. may be used to neutralize the acidic agent. In other embodiments, a sugar may be added to the the solution so that the sugar is incorporated into the particle. In yet other embodiments, a protein is added to the solution. In certain embodiments, a targeting agent is added to the solution so that the targeting agent is incorporated into the microparticles.

The aqueous solution containing the agent to be delivered and the organic solution containing the polymer are combined. In certain embodiments, the solution are combined by a fluid-handling robot. The solution may be added to multi-well plates (e.g., 24-well plates, 48-well plates, 96-well plates). In certain embodiments, deep, multi-well plates are used. Typiclly, a small amount of the aqueous solution is added to the organic solution. In certain embodiments, the ratio of the aqueous phase to the organic phase is 1:10, 1:15, 1:20, 1:25, 1:30, 1:40, 1:50, or 1:100. In certain embodiments, the ratio is approximately 1:20. In other embodiments, the ratio is approximately 1:15. In yet other embodiments, the ratio is approximately 1:25. The ratio should be such that the aqueous phase can be finely dispersed in the immiscible, organic phase using agitation. In certain embodiments, the emulsion is formed using vigorous agitation (e.g., sonication). A multi-tip probe sonicator may be used to form the primary emulsion. In certain embodiments, a 24 tip, probe sonicator is used. The duration of the sonication can range from 1 second to 60 seconds. In certain embodiments, the duration of the sonication is from 5-20 seconds. Preferably, the sonication is performed at a reduced temperature. In certain embodiments, the sonication is performed at approximately 4° C.

Once the primary emulsion is formed, it is transferred to a larger volume second aqueous phase. The transfer is typically performed using a fluid handling robot or a multi-tip pipetter. In certain embodiments, the primary emulsion is added to the well of a multi-well plate already containing the aqueous phase. In certain embodiments, the ratio of the primary emulsion to the second aqueous phase is 1:10, 1:15, 1:20, 1:25, 1:30, 1:40, 1:50, or 1:100. In certain embodiments, the ratio is approximately 1:10. In other embodiments, the ratio is approximately 1:15. In other embodiments, the ratio is approximately 1:12. In other embodiments, the ratio is approximately 1:5. In yet other embodiments, the ratio is approximately 1:25. Preferably, the primary emulsion is transferred quickly so that the primary emulsion does not begin to separate before the transfer. Once the primary emulsion and second aqueous phase are combined, the second emulsion is formed quickly thereafter via agitation. Again, the agitation is provided typically using a probe sonicator such as a multi-tip probe sonicator. The sonication is typically performed at intermediate intensity; however, higher intensities may be used to obtain smaller particles. In certain embodiments, less than 60 seconds elapse between when the first emulsion is formed and when the second emulsion is formed. In other embodiments, less than 30 seconds elapse between when the first emulsion is formed and when the second emulsion is formed. In yet other embodiments, less than 15 seconds elapse between when the first emulsion is formed and when the second emulsion is formed. In still other embodiments, less than 10 seconds elapse between when the first emulsion is formed and when the second emulsion is formed. In certain embodiments, less than 5 seconds elapse between when the first emulsion is formed and when the second emulsion is formed.

In certain embodiments, the second aqueous phase includes a surfactant. The amount of surfactant in the second aqueous phase may be varied to control the size of the resulting particles. The concentration of the surfactant in the second aqueous phase may range from 0.001% to 10%; preferably, 0.01% to 5%; more preferably, 0.1% to 2%. In certain embodiments, the concentration of the surfactant is approximately 1%. In other embodiments, the concentration of the surfactant is approximately 0.1%. In yet other embodiments, the concentration of the surfactant is approximately 0.01%.

### Surfactants

Any surfactant may be used in the second aqueous phase, from which the second emulsion is formed. In certain embodiments, the surfactant is known in the art to be suitable for use in making microparticles or for use in drug delivery. In certain embodiments, the surfactant is biocompatible. Exemplary surfactants include, but are not limited to, phosphoglycerides; phosphatidylcholines; dipalmitoyl phosphatidylcholine (DPPC); dioleylphosphatidyl ethanolamine (DOPE); dioleyloxypropyltriethylammonium (DOTMA); dioleoylphosphatidylcholine; cholesterol; cholesterol ester; diacylglycerol; diacylglycerolsuccinate; diphosphatidyl glycerol (DPPG); hexanedecanol; fatty alcohols such as polyethylene glycol (PEG); polyoxyethylene-9-lauryl ether; a surface active fatty acid, such as palmitic acid or oleic acid; fatty acids; fatty acid amides; sorbitan trioleate (Span 85) glycocholate; polysorbate 80; methyl cellulose; gelatin; surfactin; a poloxomer; a sorbitan fatty acid ester such as sorbitan trioleate; lecithin; lysolecithin; phosphatidylserine; phosphatidylinositol; sphingomyelin; phosphatidylethanolamine (cephalin); cardiolipin; phosphatidic acid; cerebrosides; dicetylphosphate; dipalmitoylphosphatidylglycerol; stearylamine; dodecylamine; hexadecyl-amine; acetyl palmitate; glycerol ricinoleate; hexadecyl sterate; isopropyl myristate; tyloxapol; poly(ethylene glycol)5000-phosphatidylethanolamine; poly(vinyl alcohol) (PVA); and phospholipids. In certain embodiments, the surfactant is polyvinyl alcohol. In certain embodiments, the surfactant is polysorbate 80. In certain embodiments, the surfactant is methyl cellulose. In certain other embodiments, the surfactant is gelatin. The surfactant used may be a mixture of different surfactants. These surfactant may be extracted and purified from a natural source or may be prepared synthetically in a laboratory. In a preferred embodiment, the surfactant is commercially available.

The second aqueous phase may contain other chemical compounds such as fillers, pharmaceutically acceptable excipients, buffers, salts, acids, bases, sugars, etc. In certain embodiments, a pharmaceutically acceptable excipient is added to the solution. In certain embodiments, an acid, base, or buffer is added to the solution. These other chemical compounds may enhance the stability of the agent(s) being incorporated into the microparticles. For example, when an acidic agent is being loaded into the microparticles, a basic compound such as NaOH, Mg(OH)₂, sodium acetate, etc. may be used to neutralize the acidic agent. In other embodiments, a salt (e.g., NaCl, Na₂SO₄, NaI, KCl, CaCl₂, MgCl₂) is added to the solution. In other embodiments, a sugar may be added to the the solution. In yet other embodiments, a protein is added to the aqueous solution. In certain embodiments, a targeting agent (e.g., receptor, ligand, antibody, antibody fragment, protein, peptide) is added to the solution.

Once the secondary emulsion is formed, the organic solvent is removed for the emulsion thereby resulting in the formation of the microparticles. In certain embodiments, the solvent is removed by evaporation at atmospheric pressure or reduced pressure. In certain embodiments, the multi-well plate is placed on a rotary plate and allowed to stir to allow for solvent evaporation. The plate may be stirred for 1-10 hours to allows the solvent to evaporate. After the solvent is removed and the microparticles have formed, the microparticles may be collected by centrifugation. The superntant is then removed. The resulting microparticles can be further washed by the addition of water or another aqueous solution. The microparticles are resuspended and then collected again. The wahsing step may be repeated 1, 2, 3, 4, or 5 times to remove any excess material not incorporated into the microparticles.

After the final wash, the microparticles can be suspended in water or an aqueous solution, frozen using liquid nitrogen, and lyophilized. The lyophilization may take multiple days (e.g., 1-5 days) to remove all water. The resulting dry microparticles can then be stored as a powder. In certain embodiments, the resulting micrparticles are stored at −20° C. in a dessicated chamber.

The resulting microparticle may be analyzed for various characteristics including size, agent delivery, biocompatibility, etc. In certain embodiments, the microparticles are used in the preparation of pharmaceutical compositions. Microparticles are useful in the treatment of diseases in humans and other animals. The different formulations of microparticles may be compared for characteristics including size, distribution, loading, release kinetics, biocompatibility, zeta potentials, morphology, etc.

### Targeting Agents

As described above, the inventive system may be used to include targeting agents in or on microparticles since it is often desirable to target a particular cell, collection of cells, tissue, organ, or organ system. A variety of targeting agents that direct pharmaceutical compositions to particular cells are known in the art (see, for example, Cotten et al. Methods Enzym. 217:618, 1993; incorporated herein by reference). The targeting agents may be included throughout the microparticle or may be only on the surface. The targeting agent may be a protein, peptide, carbohydrate, glycoprotein, lipid, small molecule, etc. The targeting agent may be used to target specific cells or tissues or may be used to promote endocytosis or phagocytosis of the particle. Examples of targeting agents include, but are not limited to, antibodies, fragments of antibodies, low-density lipoproteins (LDLs), transferrin, asialycoproteins, gp120 envelope protein of the human immunodeficiency virus (HIV), carbohydrates, receptor ligands, sialic acid, etc. If the targeting agent is included throughout the particle, the targeting agent may be included in the mixture that is used to form the particles. If the targeting agent is only on the surface, the targeting agent may be associated with (i.e., by covalent, hydrophobic, hydrogen boding, van der Waals, or other interactions) the formed particles using standard chemical techniques.

### Apparatus

The present invention also provides an apparatus for the high-throughput fabrication of microparticles. In certain embodiments, the apparatus includes all the equipment and materials needed to practice the inventive method of high-throughput fabrication of microparticles. The equipment that may be included in such an apparatus includes fluid handling robots, multi-well plate handlers, multi-tip probe sonicators, pipetting equipment, and multi-well plate centrifuges. The other matterials and reagents used by the apparatus may include multi-well plates (e.g., deep 24-well plates), buffers, water, organic solvents, polymers, agents to be delivered (e.g., drugs, small molecules, peptides, proteins, DNA, RNA, siRNA), surfactants, pharmaceuticall acceptable excipients (e.g., buffers, salts, sugars), pipette tips, etc.

These and other aspects of the present invention will be further appreciated upon consideration of the following Examples, which are intended to illustrate certain particular embodiments of the invention but are not intended to limit its scope, as defined by the claims.

### EXAMPLES

### Example 1

### High-Throughput Fabrication of Microparticle Containing Active Plasmid DNA

### Materials and Methods

### Materials

Poly(d,l-lactic-co-glycolic acid) polymer (PLGA, RG502H Resomer 50:50) was purchased from Boehringer Ingelheim (Ingelheim, Germany). Poly(β-amino ester)s (PBAE) were synthesized as previously reported (Mₙ≈7-10 kD) (Anderson, D. G., Lynn, D. M. & Langer, R. Semi-automated synthesis and screening of a large library of degradable cationic polymers for gene delivery. Angew Chem Int Ed Engl 42, 3153-3158 (2003); Lynn, D. M., Amiji, M. M. & Langer, R. pH-responsive polymer microspheres: Rapid release of encapsulated material within the range of intracellular pH. Angew. Chem.-Int. Edit. 40, 1707-1710 (2001); each of which is incorporated herein by reference). Plasmid DNA encoding firefly luciferase (pCMV-Luc) was obtained from Elim Biopharmaceuticals (Hayward, Calif.). Dextran conjugated tetramethyl rhodamine (Mₙ≈70 kD) was purchased from Molecular Probes (Eugene, Oreg.).

### Cells

The P388D1 macrophage cell line was obtained from ATCC (Manassas, Va.). Cells were cultured in RPMI 1640 media (Gibco Life Technologies; Carlsbad, Calif.) containing 10% FBS, 0.1 M HEPES, 1 mM Sodium Pyruvate, and 100 U/ml Penicillin/Streptomyocin.

### High-Throughput Preparation of Particles

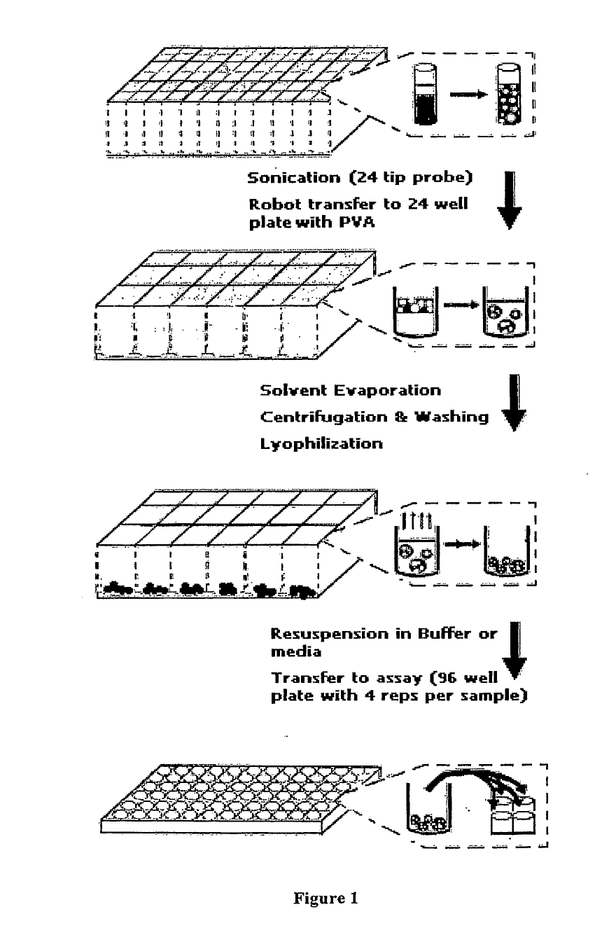

Plasmid containing microparticles were prepared by the following modification of the double emulsion technique (Odonnell, P. B. & McGinity, J. W. Preparation of microspheres by the solvent evaporation technique. Adv. Drug Deliv. Rev. 28, 25-42 (1997); incorporated herein by reference) to scale down and adapt to a high-throughput format. All steps described below were at 4° C. to minimize structural defects of the particles due to variation in polymer glass transition temperature. Lyophilized plasmid DNA was dissolved in an aqueous solution (10 mg/mL) of sterile-filtered EDTA (1 mM) and D(+)-Lactose (300 mM). 12 μl of this solution was then added to 0.25 ml of CH₂Cl₂ solution with polymer at varying degrees of composition (50 mg/ml) in a deep, 96 well plate (Corning) with a staggered formation (FIG. 1). To emulsify these immiscible phases, we utilized a 24 tip, probe sonicator attachment (Sonics and Materials Inc; Danbury, Conn.) at a setting of 47% amplitude for 10 seconds. The resulting emulsion was then immediately transferred to a solution of poly(vinyl alcohol) (120 μL into 1.5 ml, 1% PVA (w/w), 0.25 M NaCl) in deep, round bottom 24 well plates (Corning) using a 96 tip fluid handling robot. This plate was then immediately sonicated at a setting of 37% amplitude for 20 seconds to form the final water-in-oil-in-water emulsion. This plate was then placed on a rotating plate and allowed to stir for 3 hours to allow for solvent evaporation. The plate was then transferred to a refrigerated centrifuge with plate attachments and rotated at 1200 rpm for 10 min. The supernatant was removed with a 6 well aspiration wand (V & P Scientific; San Diego, Calif.) and replaced with clean water. Particles were resuspended and the process repeated three times to remove excess PVA surfactant. After the final wash, the particles were suspended in a minimal amount of water, frozen with liquid nitrogen, and allowed to lyophilize in a large vacuum chamber (Labconco; Kansas City, Miss.) at <10 mTorr for 3 days. Products in the individual wells were white, fluffy powders. Microparticles and polymers were stored at −20° C. in a desiccated chamber.

### Characterization of Particles

Microsphere size distributions were measured via volume displacement impedance using a Multisizer 3 using 30-200 μm orifice tubes (Beckman Coulter; Miami, Fla.). Zeta potentials were obtained using a ZetaPALS analyzer (Brookhaven Instruments; Holtsville, N.Y.) with 10 mM HEPES buffer at pH=7.4. Morphology of microsphere surfaces was imaged using scanning electron microscopy (SEM).

### Reporter Gene Transfection

To determine if the encapsulation process yielded active plasmid DNA, we incubated microparticles with a P388D1 macrophage cell line as previously described (Hedley, M. L., Curley, J. & Urban, R. Microspheres containing plasmid-encoded antigens elicit cytotoxic T-cell responses. Nat. Med. 4, 365-368 (1998); incorporated herein by reference). Briefly, P388D1 macrophages were seeded at 5×10⁴ cells/well in fibronectin coated, white polystyrene 96 well plates and allowed to achieve 75% confluence. Media was then replaced with suspended of pCMV-Luc plasmid DNA containing microspheres in cell media using a 96 well fluid handling robot yielding 4 reps per microparticle sample (24 to a 96 well plate format). A titration of the soluble, lipid-based transfection agent, Lipofectamine 2000 (Invitrogen), was prepared with DNA as a positive control. After a 20 hr. incubation, the media was aspirated from the samples and cells were washed with PBS. The cells were lysed by incubation for 10 minutes at room temperature with Glo Lysis Buffer (Promega, 100 μl, 1×). The wells were then analyzed for luciferase protein content using the Bright Glo Luciferase Assay System (Promega) and a Mithras plate reading luminometer (Berthold Technologies) with a 1 second read time.

### Results and Discussion

With the recent synthesis of a library composed of over 2000 PBAEs, many new promising gene delivery polymers have emerged that can perform better than the best commercially available transfection reagents (Anderson, D. G., Lynn, D. M. & Langer, R. Semi-automated synthesis and screening of a large library of degradable cationic polymers for gene delivery. Angew Chem Int Ed Engl 42, 3153-3158 (2003); incorporated herein by reference). Also, these polymers, like the PBAEs initially studied, have the potential to exhibit pH sensitive solubility and are therefore promising agents for microparticulate formulations which are suitable to differentially release in the low pH environment of an endosome or lysosome. This property makes particles prepared from these materials extremely promising for the delivery of proteins to phagocytic cells such as in the case of enzyme replacement therapy where targeted, intracellular delivery to macrophages seems to be the most logical strategy. We have also shown in a previous chapter that anionic materials can be released with an adjustable delay depending upon how much cationic polymer is added to the formulation. Furthermore, some of these cationic PBAEs have further been investigated for the effects of polymer molecular weight (Akinc, A., Anderson, D. G., Lynn, D. M. & Langer, R. Synthesis of poly(beta-amino ester)s optimized for highly effective gene delivery. Bioconjugate Chemistry 14, 979-988 (2003); incorporated herein by reference) and drug binding and complexation effects (Akinc, A., Lynn, D. M., Anderson, D. G. & Langer, R. Parallel synthesis and biophysical characterization of a degradable polymer library for gene delivery. J. Am. Chem. Soc. 125, 5316-5323 (2003); incorporated herein by reference) on delivery efficiency. To extend these types of studies to screen large numbers of polymers in a library such as the one mentioned above, however, would require an advance in the speed and efficiency in which microparticles are fabricated.

### High-Throughput Fabrication of Particles

FIG. 1 schematically represents a process intended to scale-down a standard double emulsion protocol and place it in a plate so that many particle formulations can be prepared at once. Due to differences between a standard double emulsion procedure and the proposed high-throughput method, there are several special circumstances worth noting. First, the transfer of the primary emulsion from the 96, deep-well plate to the 24, deep well plate with PVA solution must be performed as quickly as possible. In a standard double emulsion procedure, the time between these stages before the secondary emulsion is formed is close to 5 seconds. However, when transferring multiple primary emulsions, the fluid handling robot takes around 10 seconds, leaving little extra time before the droplets in this emulsion begin to grow in size. Secondly, the sonication was performed at intermediate intensities and only PVA was varied in order to alter particle size. Higher sonication rates would surely result in much smaller particles (Pfeifer, B. A., Burdick, J. A. & Langer, R. Formulation and surface modification of poly(ester-anhydride) micro- and nanospheres. Biomaterials 26, 117-124 (2005); incorporated herein by reference), however one needs to be cautious of the safety limitations of the probe in use which may limit the usage of this parameter to control particle size on its own. Thirdly, the solvent evaporation in our studies was performed at 4° C. to avoid complications related to the glass transition temperatures which may vary substantially between polymers. It should be noted that solvent evaporation will take longer periods of time to come to completion at this lower temperature. Furthermore, since the double emulsion is in a plate, rather than in a beaker with a stir-bar, as is commonplace in a standard procedure, longer solvent evaporation times may be necessary (>3 hrs.). Finally, since different particle formulations will settle differently, and some may aggregate at high centrifugation speeds, care should be taken to use low rotor speeds and cautious supernatant aspiration during washing steps to avoid irreversibly damaging or losing product.

### Characterization of Particles

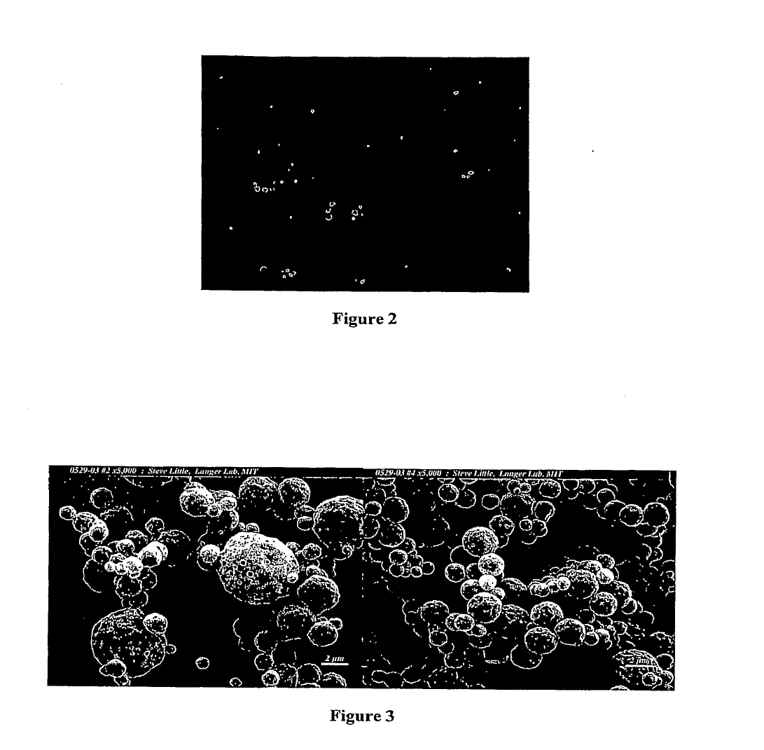

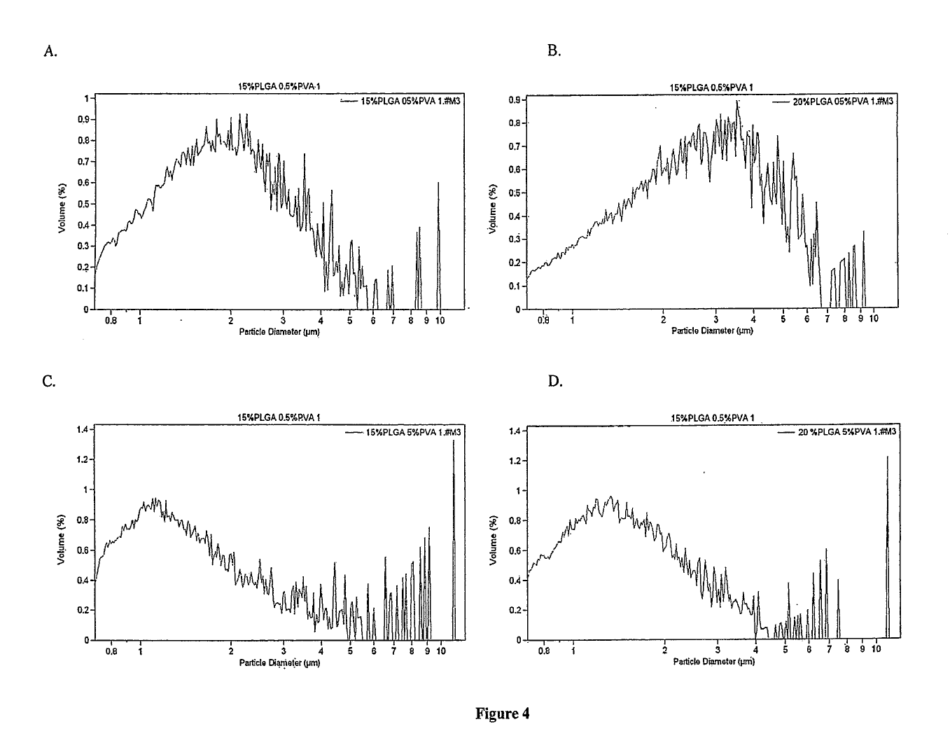

Rhodamine conjugated dextran sugar was encapsulated in particle formulations to demonstrate that a model material can be placed into polymer particles using our modified, high-throughput technique. Using fluorescence microscopy (FIG. 2), particles seemed to encapsulate relatively high quantities of material and looked similar to particles prepared using standard double emulsion. This entrapment seemed to remain consistent throughout the plate, as determined by fluorescence microscopy of microparticles taken from several different wells (data not shown). Furthermore we were able to generate multiple 24 well plates with this same consistency in encapsulation. All formulations were prepared subsequently with plasmid DNA (pCMV-Luciferase). Particles prepared with this plasmid were examined using Scanning Electron Microscopy (SEM) after standard gold sputter coating. Results indicate that particles have spherical shapes and look similar to those from standard double emulsion techniques (FIG. 3). These images also indicate that the particle has a relatively high integrity with minor flaws on the surface. These could be a result of not checking and balancing the osmolality of the internal and external aqueous phases, which has shown in previous chapters to affect drug entrapment and particle surface integrity drastically.

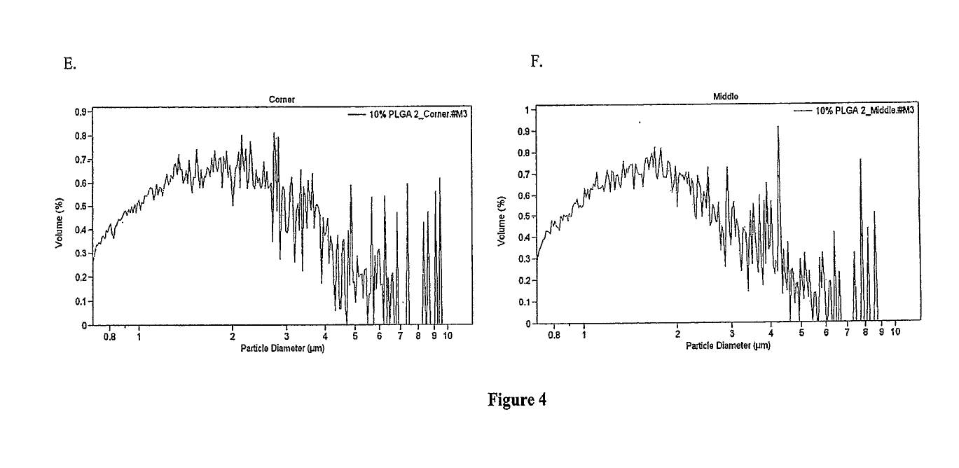

Sizes of particles were measured using a volume impedance principle on a Coulter Counter. This size seemed to be inversely dependant on the concentration of PVA used in the outer aqueous phase, as expected (Odonnell, P. B. & McGinity, J. W. Preparation of microspheres by the solvent evaporation technique. Adv. Drug Deliv. Rev. 28, 25-42 (1997); incorporated herein by reference). PVA concentrations of 5% yielded particles with mean diameters around 4 μm, while concentrations of 0.5% PVA resulted in particles with a mean diameter below 1 μm (FIG. 4A-D). It is important that this parameter be easily adjustable given the many physical properties the particle size influences (e.g., cellular uptake, release, loading). The only limitation of the technique described herein is that particle size cannot be changed with respect to different wells in the same fabrication plate. This stems from the sonication amplitude output being constant in every tip of the 24 arm probe. This is demonstrated by sizing random wells on the periphery and the center and comparing mean diameters. In our study, there was no statistical difference between these two values in any case (FIGS. 4E-F).

### Entrapment of Active Plasmid DNA

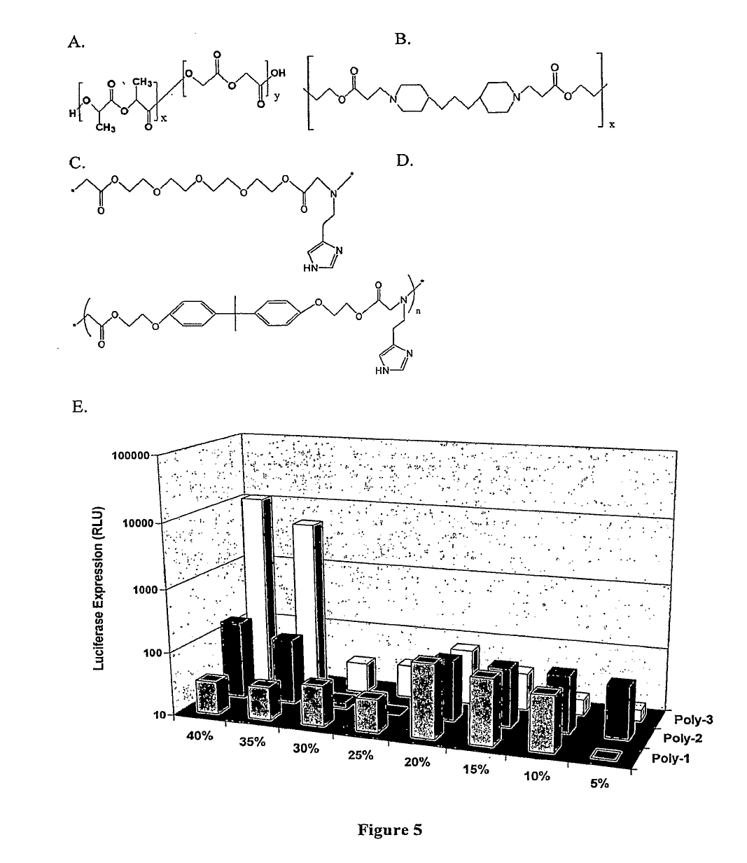

Therapeutic agents may not always be fully active after the encapsulation process. This can be due to many factors including: 1) sheer forces, 2) organic solvent phase interactions, 3) internal particle microclimate, and 4) drug-polymer interactions. Ando et. al. addressed this issue in the case of plasmid DNA encapsulation and suggested modifications to these processes to better suit this particular pro-drug (Ando, S., Putnam, D., Pack, D. W. & Langer, R. PLGA microspheres containing plasmid DNA: Preservation of supercoiled DNA via cryopreparation and carbohydrate stabilization. J. Pharm. Sci. 88, 126-130 (1999); incorporated herein by reference). Zhu et. al. addressed this issue from a protein standpoint using PLGA microparticles (Zhu, G., Mallery, S. R. & Schwendeman, S. P. Stabilization of proteins encapsulated in injectable poly (lactide-co-glycolide). Nat Biotechnol 18, 52-57 (2000); incorporated herein by reference). It is extremely important for any new fabrication technique to allow for encapsulation of a material in its biologically active state. As related to the new methods described here, different forces are present, such as vigorous sonication in place of a homogenization step and/or differences in turbulence between a 24, deep well vs. a 100 ml beaker. To evaluate the activity of encapsulated material, we used PLGA (FIG. 5A) blended with a polymer (Poly-1, FIG. 5B) which is known to exhibit transfection in a P388D1 macrophage cell line. Particles were prepared using different ratios of the two polymers (40% Poly-1:60% PLGA to 5% Poly-1:95% PLGA) and were resuspended in P388D1 cell culture media. These particles were added to the cells (similar to last stage of FIG. 1) and incubated for 3 days before testing for luciferase expression using luciferin and ATP.

The results of this assay conform to the results obtained previously using Poly-1 as a delivery enhancer in a similar optimum polymer ratio range (FIG. 5, blue bars, four repetitions). This data also confirms that active plasmid has been successfully encapsulated. It should be noted that only a 1 sec luminometer read time was used in these studies instead of the 10 read times used in previous chapters. The reason for this change was to avoid going outside the linear range of the machine if one of the other polymers tested in this study proved to be as effective here as in the case of spontaneously formed polymer/DNA complexes (Anderson, D. G., Lynn, D. M. & Langer, R. Semi-automated synthesis and screening of a large library of degradable cationic polymers for gene delivery. Angew Chem Int Ed Engl 42, 3153-3158 (2003); incorporated herein by reference).

### Effects of Varying Polymer Ratio of Two New PBAEs in Microparticle Formulations

Two new PBAEs were chosen from the 2000+ library and incorporated into microparticle formulations using the high-throughput double emulsion procedure to serve as a pilot example for the usefulness of this technology. As previously discussed, Poly-1 was varied from 40% to 5% in 5% increments (eight total formulations compared to the 5 used in previous studies with this polymer). In the same plate, Poly-2 and Poly-3 (FIG. 5C-D, respectively) were varied using the same ratios with respect to PLGA content (bringing the total number of particle formulations to 24). In the cellular transfection assay, we observed that Poly-2 did not demonstrate substantial differences when compared to Poly-1. However, Poly-3 boasted a 2 order of magnitude increase at 35 and 40% compared to Poly-1's best formulation (recall that Poly-1 transfects up to 5 orders of magnitude greater than PLGA alone). It should be noted that these 24 particle formulations were prepared in 4-5 hours, while the same number of formulations prepared by a standard double emulsion procedure would have taken 3 full days worth of work to produce. It will be extremely interesting to test the promising Poly-3, and other new polymers more extensively using this technology in the future.

The speed in which this technique allows for microparticles to be fabricated provides a valuable tool to study variations in particle formulations in many ways. Just one example of this is the enablement of rapid testing for release profiles. Particles could conceivably be prepared using different ratios of polymers, molecular weights, and excipients containing drugs which currently can be detected in extremely low amounts using new technologies (proteins can be measured in the pico to nanogram range using ELISA; double stranded DNA such as plasmid can be measured in the picogram range using base-pair intercalating agents such as PicoGreen) by release in a 96 well plates. The plate can be centrifuged, supernatant removed/analyzed, and new buffer/media can replace and resuspend particles to collect released drug for the next time point. Furthermore, since the disclosed fabrication method now enables a researcher to prepare over 100 microparticle formulations in a day, the experiment involving genetic vaccines mentioned earlier which was infeasible with standard technologies, now becomes a reality. With respect to choosing the best reagents for final usage in-vivo, sadly, the appropriate understanding is now one step behind in the development of relevant assays which would best predict whether a particle formulation created on the bench-top will be useful to a patient at bedside.

### Other Embodiments

The foregoing has been a description of certain non-limiting preferred embodiments of the invention. Those of ordinary skill in the art will appreciate that various changes and modifications to this description may be made without departing from the spirit or scope of the present invention, as defined in the following claims.

1. (canceled)

2. (canceled)

3. (canceled)

4. A high-throughput method of preparing multiple microparticle formulations in parallel, the method comprising steps of:
(a) providing a first solution of a polymer;
(b) adding a second solution, which comprises an agent to be incorporated into microparticles, to the first solution, wherein the two solutions are not miscible;
(c) forming an emulsion of the first solution and the second solution;
(d) adding the emulsion formed in step (c) to a third solution, wherein the third solution comprises a surfactant;
(e) forming a second emulsion of the third solution and the emulsion formed in step (c); and
(f) removing any organic solvent by evaporation;
wherein the method provides for the preparation of at least 10 different microparticle formulations in parallel.

5. A high-throughput method of preparing multiple microparticle formulations in parallel, the method comprising steps of:
(a) providing a polymer dissolved in an organic solvent;
(b) adding a first aqueous phase to the polymer solution, wherein the first aqueous phase comprises an agent to be incorporated into microparticles;
(c) forming an emulsion of the organic polymer solution and the first aqueous phase;
(d) adding the emulsion formed in step (c) to a second aqueous phase, wherein the second aqueous phase comprises a surfactant;
(e) forming a water-in-oil-in-water emulsion of the second aqueous phase and the emulsion formed in step (c); and
(f) removing the solvent by evaporation;
wherein the method provides for the preparation of at least 10 different microparticle formulations in parallel.

6. A high-throughput method of preparing multiple microparticle formulations in parallel, the method comprising steps of:
(a) providing a polymer and an agent dissolved in an organic solvent;
(b) adding the organic polymer/agent solution to an aqueous solution, wherein the aqueous solution comprises a surfactant;
(c) forming an emulsion of the organic polymer/agent solution and the aqueous solution;
(d) forming an oil-in-water emulsion of the aqueous solution and the organic solution; and
(e) removing the solvent by evaporation;
wherein the method provides for the preparation of at least 10 different microparticle formulations in parallel.

7. The high-throughput method of claim 4, wherein at least 24 different microparticle formulations are prepared in parallel.

8. (canceled)

9. The high-throughput method of claim 4, wherein at least 96 different microparticle formulations are prepared in parallel.

10. The high-throughput method of claim 4, wherein at least 192 different microparticle formulations are prepared in parallel.

11. The high-throughput method of claim 4, wherein at least 250 different microparticle formulations are prepared in parallel.

12. (canceled)

13. The high-throughput method of claim 4, wherein step (b) comprises adding the aqueous phase to the organic polymer solution at a ratio of 1 part aqueous to 20 parts organic.

14. The high-throughput method of claim 4, wherein step (b) comprises adding the aqueous phase to the organic polymer solution at a ratio of 1 part aqueous to 10 parts organic.

15. The high-throughput method of claim 4, wherein step (b) comprises adding the aqueous phase to the organic polymer solution at a ratio of 1 part aqueous to 25 parts organic.

16. The high-throughput method of claim 4, wherein step (b) comprises adding the aqueous phase to the organic polymer solution at a ratio of 1 part aqueous to 30 parts organic.

17. The high-throughput method of claim 4, wherein step (c) comprises forming the emulsion by agitation or sonication.

18. (canceled)

19. The high-throughput method of claim 4, wherein step (c) comprises forming an emulsion of aqueous bubbles within the organic solvent.

20. The high-throughput method of claim 4, wherein step (e) comprises forming the emulsion by agitation or sonication.

21. (canceled)

22. The high-throughput method of claim 4, wherein step (d) is performed by a fluid handling robot.

23. The high-throughput method of claim 4, wherein step (d) comprises adding the first emulsion to the second aqueous phase at a ratio of 1 part emulsion to 10 parts aqueous.

24. The high-throughput method of claim 4, wherein step (d) comprises adding the first emulsion to the second aqueous phase at a ratio of 1 part emulsion to 12 parts aqueous.

25. The high-throughput method of claim 4, wherein step (d) comprises adding the first emulsion to the second aqueous phase at a ratio of 1 part emulsion to 15 parts aqueous.

26. The high-throughput method of claim 4, wherein step (d) comprises adding the first emulsion to the second aqueous phase at a ratio of 1 part emulsion to 20 parts aqueous.

27. The high-throughput method of claim 4, wherein at least one step is performed at approximately 4° C.

28. The high-throughput method of claim 4, wherein all the steps are performed at approximately 4° C.

29. The high-throughput method of claim 4, wherein the agent is a polynucleotide.

30. The high-throughput method of claim 4, wherein the agent is DNA.

31. The high-throughput method of claim 4, wherein the agent is a protein.

32. (canceled)

33. The high-throughput method of claim 4, wherein the polymer is a synthetic polymer.

34. The high-throughput method of claim 4, wherein the polymer is a polyester.

35. The high-throughput method of claim 4, wherein the polymer is PLGA.

36. The high-throughput method of claim 4, wherein the polymer is a poly(beta-amino ester).

37. The high-throughput method of claim 4, wherein the polymer is a blend of at least two polymers.

38. The high-throughput method of claim 37, wherein at one polymer in the blend in PLGA.

39. The high-throughput method of claim 4, wherein the surfactant is poly(vinyl alcohol) (PVA).

40. The high-throughput method of claim 4, wherein the concentration of poly(vinyl alcohol) (PVA) is in the range from 0.1% to 10%.

41. The high-throughput method of claim 4, wherein the concentration of poly(vinyl alcohol) (PVA) is in the range from 0.5% to 5%.

42. The high-throughput method of claim 4, wherein the organic solvent is chloroform, methylene chloride (CH₂Cl₂), or ethyl acetate.

43. (canceled)

44. (canceled)

45. The high-throughput method of claim 4 further comprising the step of washing the microparticles.

46. The high-throughput method of claim 4 further comprising the step of freeze drying the microparticles.

47. The high-throughput method of claim 4, wherein the resulting microparticles have a mean diameter ranging from 1 to 10 μm.

48. The high-throughput method of claim 4, wherein the resulting microparticles have a mean diameter ranging from 1 to 5 μm.

49. (canceled)

50. An apparatus for high-throughput fabrication of microparticles comprising a fluid handling robot, a multi-well plate handler, and a multi-tip probe sonicator.

51. The apparatus of claim 50 further comprising multi-well plates, tips for fluid delivery, water, organic solvents, polymers, and surfactants.

52. The apparatus of claim 50 further comprising a Coulter counter.

53. The apparatus of claim 50 further comprising a multi-well plate centrifuge.
